(19) United States
(12) Patent Application Publication
(10) Pub. No.: US 2006/0053169 A1
(43) Pub. Date: Mar. 9, 2006

(54) System and method for management of data repositories

(76) Inventors: Roland Urs Straub, Zug (CH); Fidel Figueroa JR., Fort Collins, CO (US)

Correspondence Address: COOLEY GODWARD LLP;One Freedom Square, Reston Town Center, 11951 Freedom Drive, Reston, VA, 20190-5656, US

(21) Appl. No.: 10/937,179

(22) Filed: Sep. 9, 2004

(51) Int. Cl. G06F 17/30

(52) U.S. Cl. 707/200

(57) ABSTRACT

A system and method for managing a data repository is described. One embodiment receives an index and metadata corresponding to a document and using the received metadata, identifies a rule that corresponds to the index. This embodiment next determines whether the document is a candidate document by comparing at least one of the plurality of knowledge set against the received index. And responsive to determining that the document is a candidate document, generating a tagged document. Finally, this embodiment determines whether the document satisfies the rule by comparing the tagged document against the definition that define the relationships between the plurality of knowledge sets.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to data management. In particular, but not by way of limitation, the present invention relates to systems and methods for searching, categorizing, and packaging data from disparate data repositories that include, for example, structured data, unstructured data, images, etc.

### BACKGROUND OF THE INVENTION

Large data repositories are generally searched using weighting algorithms or by counting links to references or documents. These methods are only minimally acceptable when searching for documents relevant to specific behavior patterns or search criteria. For example, companies cannot rely on current search technology to identify all documents where an officer of the company was offered a loan. Instead, using current technology, a company would be forced to form search queries that included each officer's name and “loan.” Of course, the word “loan” could be disguised in the document, so the search query should also include synonyms for “loan” and possible other triggering words to indicate that a loan is being discussed.

The construction of such elaborate queries is difficult. First, the query itself would be difficult to structurally form. Second, the person creating the query would need significant knowledge about the company and the topic, loans to officers, to be able to form the query. For many topics, lawyers or accountants might be necessary to provide enough contextual knowledge to accurately construct the query.

Manually constructed queries of this type are unacceptable for several reasons. First, they are difficult and expensive to prepare—assuming that they can be prepared at all. Second, several different people might be necessary to construct the query. For example, a technology specialist, an employee from human resources, and a corporate lawyer might be necessary to formulate a single query to identify the documents in which loans were made or offered to company officers. And third, manually created queries are not easily updated and may be made obsolete by changing company personnel, changing compliance standards, or changing laws.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

A system and method for managing a data repository is described. One embodiment receives an index and metadata corresponding to a document and using the received metadata, identifies a rule that corresponds to the index. This embodiment next determines whether the document is a candidate document by comparing that document, or an index representation of that document, against at least one of the knowledge sets. And responsive to determining that the document is a candidate document, generating a tagged document. Finally, this embodiment determines whether the document satisfies the rule by comparing the tagged document against the definition that define relationships between the plurality of knowledge sets.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a block diagram of one embodiment of the present invention;

FIG. 2 is a flowchart illustrating one method of identifying documents according to the present invention;

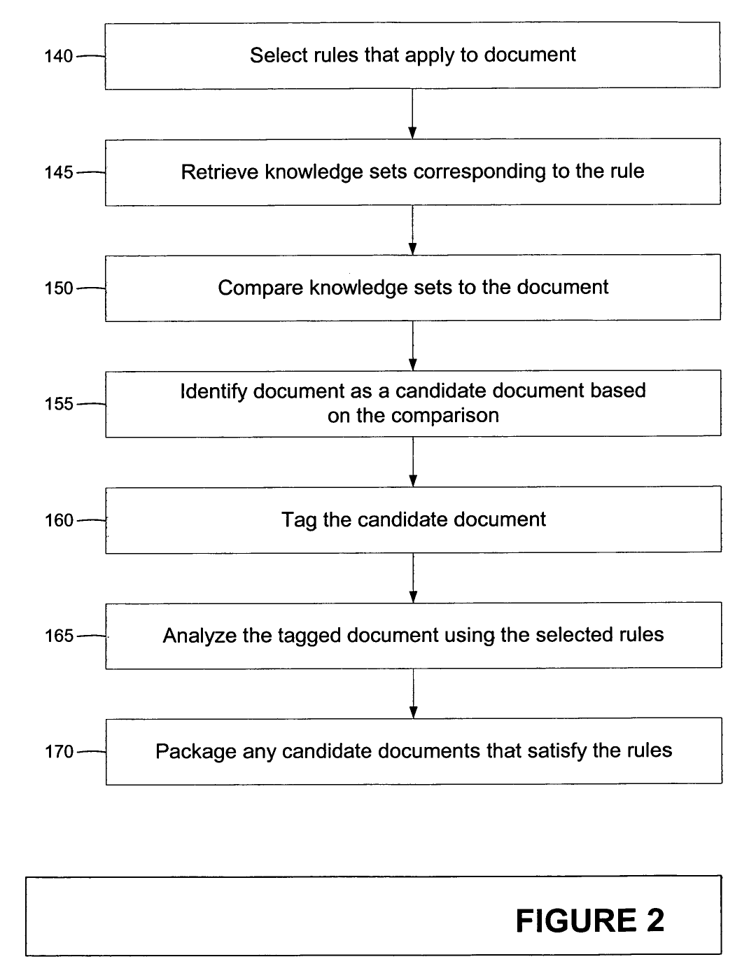

FIG. 3 is a block diagram of one implementation of a rule-definition module;

FIG. 4 is a flowchart illustrating one method for identifying inventions according to the present invention;

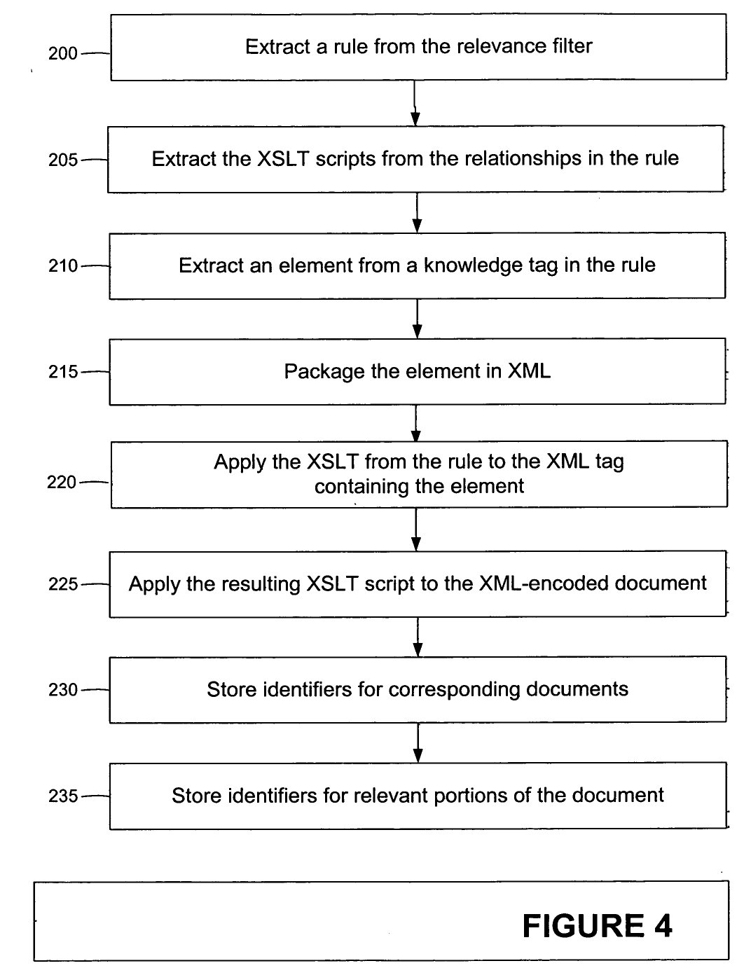

FIG. 5 is a diagram illustrating one method for transcoding a document; and

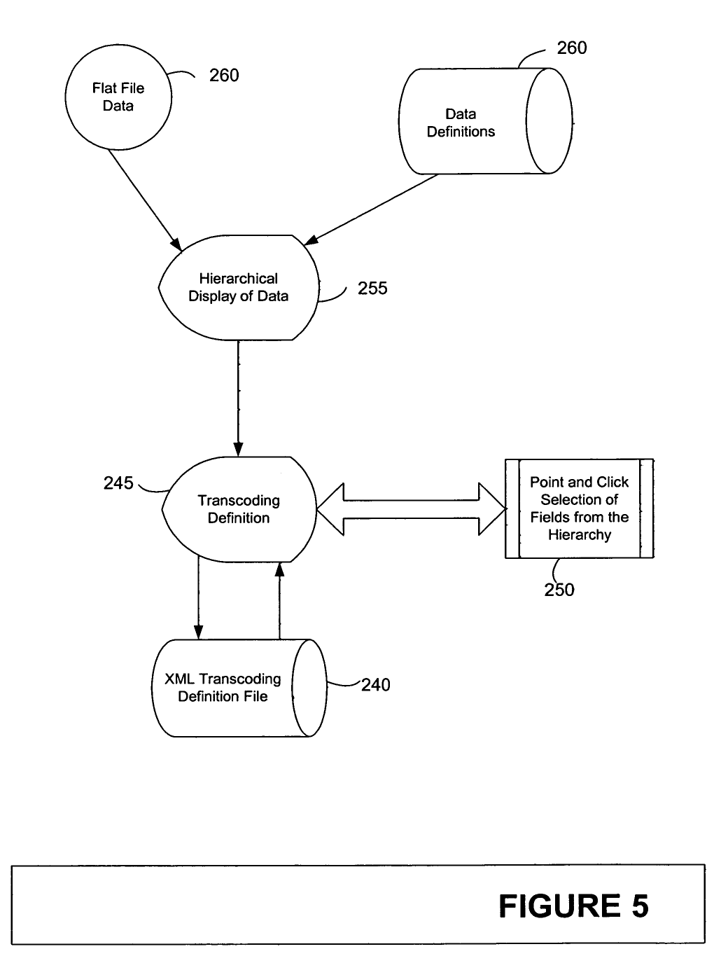

FIG. 6 is a diagram illustrating another method for transcoding a document.

### DETAILED DESCRIPTION

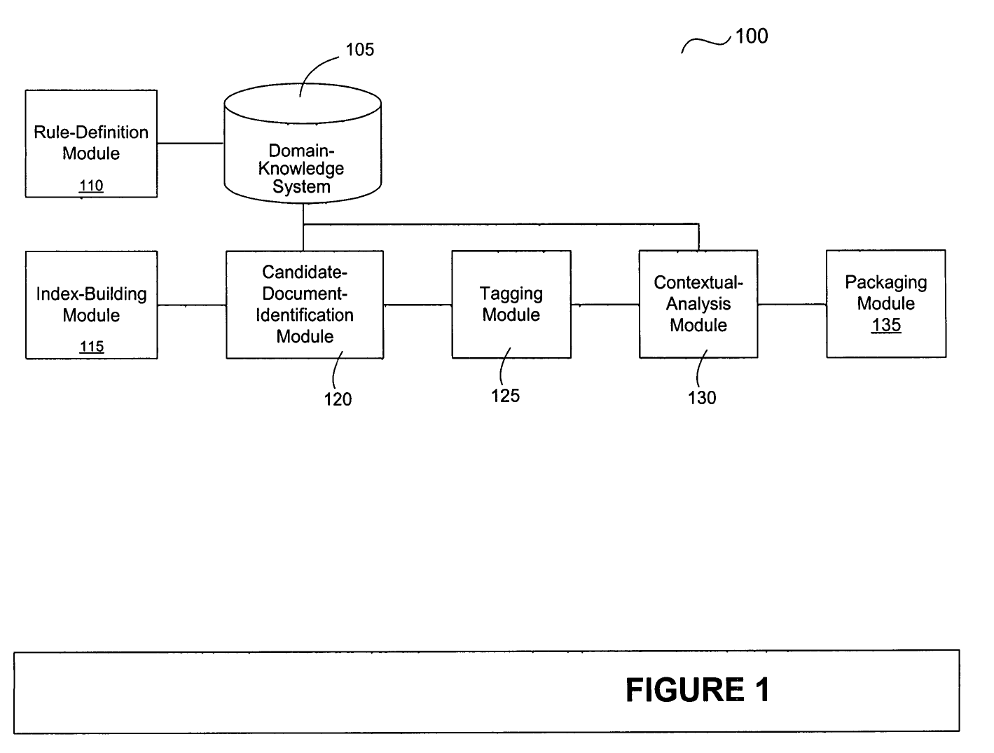

Referring now to the drawings, where like or similar elements are designated with identical reference numerals throughout the several views, and referring in particular to FIG. 1, it illustrates a block diagram of the modules in one embodiment 100 of the present invention. This embodiment includes five basic modules and a domain knowledge storage system 105. The five basic modules include a rule-definition module 110, an index-building module 115, candidate-document-identification module 120, a tagging module 125, a contextual-analysis module 130, and a packaging module 135. In certain embodiments, the functionality provided by one or some of these modules can be combined into a single module or divided among other modules. Not all functionality provided by these modules is necessary for all embodiments of the invention.

When these components, or their functionality, are combined, a powerful searching, monitoring, and enforcement tool is created. This tool enables companies, for example, to monitor employee behavior, to monitor for compliance with federal and state law, to research patterns in business activities, etc. For example, recent changes in the law require companies to monitor loans made to officers of the company. Using traditional search technology, it would be difficult, if possible at all, to monitor the documents generated in a company for loans made to officers. A simple word search for “loans” and “officers” or a traditional relevance search alone is unlikely to turn up all or even most of the relevant documents. Alternatively, these searches could identify a set of documents too large to manage. But the system shown in FIG. 1 addresses these issues by providing for two phases of searching, both based on the data in the domain-knowledge system 105.

In this system 100, rules are defined for the types of documents and relationships being sought. For example, rules could be titled “Sarbanes-Oxley Compliance” or “Off-ledger Transactions” or “Loans to Officers.” Each of these rules would have one or more knowledge sets associated with it. Knowledge sets can be a list of synonyms or related terms that are relevant to a particular rule or domain in which a search will be executed. Knowledge sets and rules can be stored at the domain-knowledge system 105.

Mathematically, a knowledge set can be considered as a list of terms. Linguistically, it can be considered as a short thesaurus related to one master topic and/or a list of related topics or domains. For example, in the domain of U.S. politics, a knowledge set could be entitled “U.S. Presidents” and contain the terms “Bush,” “Clinton,” “Reagan,” “Nixon,” “Carter,” “Kennedy,” and “Johnson.” In the same domain, U.S. politics, another knowledge set named “Tried” might contain the terms “impeached,” “tried,” “prosecuted,” and “indicted.” This knowledge set could also include a reference to another knowledge set such as “criminal proceedings.”

In the corporate domain, a knowledge set could be lists of data such as company officers, office locations, job scope, etc. The “company officers” list could include, for example, the names and titles of all of the company officers. It could also include a list of the officers' family members. Thus, when searching for “loans” to “company officers,” the system could search for loans to anyone on the list, including family members. The “loan” knowledge set could include synonyms for “loan” and any other key words usually associated with a loan such as “interest,” “annualized,” “collateral,” “note,” etc.

Rules can be defined by linking knowledge sets to form relationships. Rules are used to analyze the context of a document. For example, a rule can be defined that identifies any document (including email, word docs, instant messages, etc.) sent from a “company officer” to a “board member” where a “meeting” was set and the text referred to a “loan.” “Company officer,” “board member,” “meeting” and “loan” correspond to knowledge sets. And the rule defines the relationships between those knowledge sets.

Rules and knowledge sets are stored in the domain-knowledge system 105 and can be reused to define other rules or knowledge sets. Additionally, rule templates and knowledge-set templates can be stored in the domain knowledge system 105. These templates can be used to generate new rules or knowledge sets.

Documents are generally indexed by the index-building module 115 before they are compared against any of these stored rules. This index-building module 115 is often a stand-alone unit that automatically indexes documents as they are placed in target folders, sometimes referred to as “watch folders.” The output of the index-building module 115 is a representation of a document that can be quickly compared against a rule.

But a typical domain-knowledge system 105 could include hundreds to thousands of rules, and many of these rules could be irrelevant to a particular document. Accordingly, the first step to analyzing an indexed document, in this implementation, is to select which rules from the domain-knowledge system 105 should be executed against that indexed document. (Block 140) And the rules are selected based on metadata in the document itself or other document information. For example, rules could be selected based on the document author, document recipient, document type, document folder, etc.

Once the correct rule(s) has been selected for a particular document, the knowledge sets associated with that rule are retrieved and compared against the indexed document. (Block 145 and 150) This is typically an “AND” search for keywords. If the keywords are found in the document, then the document is identified as a candidate document and passed on for further analysis. (Block 155) If the keywords are not found in the document, then the document is discarded.

Assuming that a document is identified as a candidate document, it can be fully tagged by the tagging module 125. (Block 160) This implementation of the tagging module 125 uses XML tags, but those of skill in the art should understand that any type of tagging system or labeling system can be used.

Next, the contextual-analysis module 130 compares the tagged documents against the selected rule(s) and searches for relationships between the relevant knowledge sets. (Block 165) If the relationship is identified, the document, or portions of the document, is identified and optionally packaged by the packaging module 135. (Block 170) Generally, users request that identified documents be packaged. In some embodiments, however, packaging can be done automatically.

Each of these six modules and their functionalities is described in detail below. As previously stated, however, the functionality of the modules can be combined into single modules or further divided into other modules. Similarly, the detailed description of the modules and how they perform their functions is only exemplary.

### Rule Definition Module

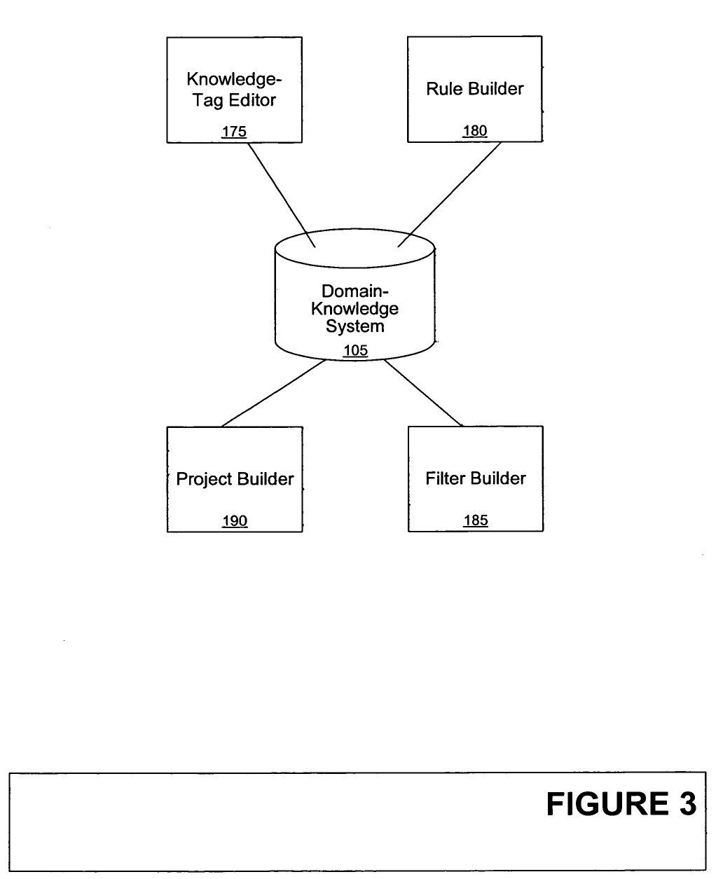

Rules can be defined using a rule editor 175 that is part of a graphical user interface. The rule editor can include several functional components, including a knowledge-set editor 175, a rule builder 180, a filter builder, and a project builder 190. Each of these components is described below in more detail and illustrated in FIG. 3.

Knowledge-set Editor—The knowledge-set editor 175 allows the user to create, edit, or delete knowledge sets, which are most often a simple list of text elements. Each element in the list can be a string of text of any length. The elements could also be images, and any reference to a string, item, or element should be understood as including text, images, or any other computer representation of data.

When the elements in the knowledge set are string based, the string may be a word, a phrase, or a sentence, or even a paragraph. During a search, these elements can be compared against retrieved documents, and each element in a knowledge set should be located within a document for that document to be identified as a candidate document. Elements in a knowledge set are also used to populate rules that require particular relationships. This rule population is discussed in greater detail in a subsequent section.

Rule Builder—The rule builder 180 allows rules to be created, edited, or deleted. Rules are named objects and exist as collections of relationships often defining an “IF . . . Then” decision. Rules can be defined by selecting a set of relationships from a pre-defined library of relationships. One implementation of this is to select relationships from a list by checking windows check boxes against those that are desired in the rule.

Relationships within a rule can be generic processing scripts written in eXstensible Style Sheet Language. These XLST scripts can be generated by a user or automatically by the system. Further, these XSLT scripts are designed to execute first against XML encoded elements extracted from knowledge sets. This first phase execution produces a new XSLT stream that is designed to execute against an XML-encoded document. The result of that second phase execution will generally be ‘True’ or ‘False.’

Most defined relationships require domain-specific knowledge, which broadly is information about context, including word placement, document type, document creator, document distribution list, company positions of document creator and recipients, document access, document editing, document emailing, etc. Where domain-specific knowledge is needed, a method can be provided for users to indicate which knowledge sets from the domain-knowledge system 105 should be referenced by the rule for that relationship. One implementation uses the word SELECTION in the relationship. Anytime the word SELECTION is shown, the user can select it with the mouse and a dialog will open allowing one of the known knowledge sets to be chosen for replacement of the word SELECTION in the relationship.

Rules are designed knowing that all relationships chosen for inclusion in a given rule are generally evaluated on an AND basis. That is, all the relationships must be true for the rule to be true.

Filter Builder—The filter builder 185 allows the user to create, edit, or delete collections of rules. Filters are stored objects and can be a prime component of executable projects. Filters are generally designed knowing that the rules making up a filter are evaluated on an OR basis. That is, any of the rules in a filter being true will allow a candidate document to pass through the filter to become part of the set of documents that are considered relevant to the query.

Project Builder—The project builder 190 allows the user to create, save, or delete a set of selected filters and other related information. Projects are stored as named objects that may be executed as a query processing job. Projects may be executed ad hoc or on a scheduled basis.

### Index Building Module

Documents that will be searched in the future are initially full-text indexed. Often, indexing runs as a stand alone service on a computer server. Initially, the index building module 115 (also called an “indexer”) is provided with references to a set of folders to watch. These watch folders, which can be any storage device or area, are often presented to the indexer through a web service using the Simple Object Access Protocol (SOAP). The folders can be designated by universal resource identifiers (URI's). Multiple indexers 115 can be started on the same physical server or on multiple physical servers. Each of the indexers 115 could write its output to a common index repository. Alternatively, the indexers 115 could write their output to a volatile memory for further processing.

Documents (including database records and emails) that arrive in any of the watched folders can be selected for full-text indexing. The full-text indexing algorithm, in one implementation, is a bitmapped index algorithm. Each record is read and each blank delimited word is hashed to a numeric value between 0 and 255. This number is then used as an index into a set of one-dimensional bitmaps stored in memory. The bit representing the number of the current record in the file is set to binary one.

At the end of the document (when the last record is read and each word hashed) the index built-up in memory is written to disk. The indexer 115 stores the index in a common repository. Generally, the indexed document is stored in a disk folder that holds multiple document indexes, one per file. Along with the bitmapped index for each file, eXtensible Markup Language can be used to tag metadata about the document such as creation date, document size, author, recipient, editing information, defined metadata based on document type, and other relevant information. The URI to locate the file in its native repository is stored in an XML tag as well. The document itself is, most often, neither modified nor copied. The output from the indexer for any given document is a new index of that document.

Once a file is indexed and stored, the indexer 11 5 moves on to the next document in the watch folders it has been assigned. As each document is indexed, the indexer stores its name in memory to insure that no document is indexed twice. When no documents are found that require indexing, the indexer 115 enters a sleep state waiting until the watch folders it is assigned to change.

### Candidate—Document Identification Module

The defined rules and the full-text index of the documents can be used for a first stage search, which typically include searching for knowledge sets or elements within the document or the document metadata. The data being sought in the document is referred to as a “search key.” Search keys correspond to elements within knowledge sets.

As previously described, rules, including corresponding knowledge sets and search keys, are selected for a document based on information such as where the document originated, author, document type, recipient, date, etc. Stated differently, data about the document is used to locate a defined rule, and the knowledge sets within that rule are used to search the document. For example, if a document originates from a folder entitled INVOICES, then the rule entitled INVOICE AUTHORIZATION could be retrieved. This rule could contain several knowledge sets, each knowledge set including several elements, which correspond to search keys. The document could then be compared against each knowledge set and element. If the document and knowledge sets match, then the document is a candidate document corresponding to the INVOICE AUTHORIZATION rule. Note that the first stage search can provide capabilities beyond element matching. For example, the search can also look for logical relationships such as “invoice total is greater than 10,000” or “invoice date is later than Oct. 4, 2003.”

The actual search of a document with a search key can be done in several ways. For example, the search key can be hashed on a word for word basis, and the relevant rows of bits (bitmaps) extracted from the index file and logically ANDed together. The resultant bitmap will only contain document identifiers/date element identifier for those source data elements that either do or are most likely to contain the search key. These are candidate data elements. Each candidate data element is scanned in turn to determine if it actually does contain the search key and if so, the candidate data element or the entire document (or a corresponding pointer) is returned as candidate document.

In one implementation, candidate documents (e.g., tables, records, etc.) can also be identified in structured data and databases. To apply a relevance rule or filter to structured data, the rule can include a standard SQL-style query. That query is presented to the contextual-analysis module 130 and possibly an SQL Query translator and handler. If the query is already in SQL (as is usually the case), the query is used to search the candidate documents or a summary of the candidate documents. Otherwise, the query is parsed and interpreted into SQL, then passed to the SQL interface.

The result of executing the query is generally either a record set returned as a table or a view (a virtual table created by having the database logically join related records into a virtual table). If there are subsequent queries to present to the view, they will have been stacked behind the initial query and a flag set to indicate that they should be executed before the final resulting record set is handed to the calling program. Most of the time, such stacked queries are managed by creating more complex SQL statements or by placing the entire query in a stored procedure and passing the call to the procedure to the search engine as if it were a primitive query.

The ultimate record set is passed back to the contextual-analysis module 130, where each record in the record set can be treated as a fine in a document. While this typically means the virtual document is very structured and repetitive, the ability to process rule-based queries against this virtual document is powerful.

### Tagging Module

Once a document has been identified as a candidate document, it can be tagged by the tagging module 125 to enable further searching. The tagging module 125 converts candidate documents into an XML-tagged data stream, including documents in PDF, line, or text format.

The conversion into XML involves a parsing of the document into a set of structures based on recognition of logical document elements within the document. These elements consist of headings, titles, paragraphs, sentences, phrases, and words. Linguistic elements such as subjects and predicates are not recognized by the process described below.

The recognition of document elements allows tags to be wrapped around relevant aspects of the document and passed to the XSLT-based processing logic of a higher level program. The process is described below.

The first phase of the document-tagging process starts when a candidate document needs to be transformed into an XML data stream that can be processed by XSLT (eXtensible Stylesheet Language for Transforms). For example, the document-identification module 125 can invoke the tagging process by passing a candidate document to the tagging module 125 where the candidate document is parsed into a parsed document tree of document elements. This parsed document tree is then re-iteratively processed to tag the document.

The document is parsed into large-scale elements such as Titles and Paragraphs. These are tagged with high level tags. The text of such elements is passed in as the content of the wrapping tags.

Paragraph tagging is performed when a paragraph break is encountered. Paragraph breaks are defined either by the presence of the ASCII Carriage Return/Line Feed (CRLF) byte sequence (0x′0D0A′) or by a continuous line of ASCII space characters (0x′20′) more than 70 bytes in length. This is considered to be a blank line. With just paragraph tagging, the tagged document appears as follows in memory:

```
<DOCUMENT>
  <PAGE>
  <PARAGRAPH>
      The text of the first paragraph. The text of the
      second paragraph follows in its own paragraph tag.
  </PARAGRAPH>
  <PARAGRAPH>
      The text of the second paragraph. This paragraph is
      separated from the previous paragraph by an ASCII
      carriage return/line feed byte sequence.
  </PARAGRAPH>
  </PAGE>
</DOCUMENT>
```

The contents of PARAGRAPH tags can be further parsed into sentences. Sentences are recognized as strings of ASCII characters terminated by a punctuation character other than the comma (‘,’). These sentence strings are again wrapped in lower level tags. Once again the text is the content of the tag and attributes are not used.

With paragraph and sentence tagging, the tagged document appears as follows in memory:

```
<DOCUMENT>
  <PAGE>
  <PARAGRAPH>
    <SENTENCE>
      The text of the first paragraph.
    </SENTENCE>
    <SENTENCE>
      The text of the second paragraph follows in its own
      paragraph tag.
    </SENTENCE>
  </PARAGRAPH>
  <PARAGRAPH>
    <SENTENCE>
      The text of the second paragraph.
    </SENTENCE>
    <SENTENCE>
      This paragraph is separated from the previous
      paragraph by an ASCII carriage return/line feed byte
      sequence.
    </SENTENCE>
  </PARAGRAPH>
  </PAGE>
</DOCUMENT>
```

The sentence strings can be further parsed into words and parts of speech including nouns, verbs and objects (collectively referred to as “words.”) Words are defined as space (0x′20) delimited strings of ASCII characters. However, the last byte of each such word is tested to see if it is a letter (A-Z, a-z) or a digit (0-9) and, if not, it is assumed to be a punctuation mark. The mark is stripped from the word and saved. After the word is tagged with <WORD> and </WORD> tags, the punctuation character is placed after the </WORD> tag as shown below.

With paragraph, sentence, and word tagging, the tagged document appears as follows in memory:

```
<DOCUMENT>
  <PAGE>
  <PARAGRAPH>
    <SENTENCE>
      <WORD>The</WORD>
      <WORD>text</WORD>
      <WORD>of</WORD>
      <WORD>the</WORD><WORD>first</WORD>
      <WORD>paragraph</WORD>.
    </SENTENCE>
    <SENTENCE>
      <WORD>The</WORD>
      <WORD>text</WORD>
      <WORD>of</WORD>
      <WORD>the</WORD>
      <WORD>second</WORD>
      <WORD>paragraph</WORD>
      <WORD>follows</WORD>
      <WORD>in</WORD>
      <WORD>its</WORD>
      <WORD>own</WORD>
      <WORD>paragraph</WORD>
      <WORD>tag</WORD>.
    </SENTENCE>
  </PARAGRAPH>
  <PARAGRAPH>
    <SENTENCE>
      <WORD>The</WORD>
      <WORD>text</WORD>
      <WORD>of</WORD>
      <WORD>the</WORD>
      <WORD>second</WORD>
      <WORD>paragraph</WORD>.
    </SENTENCE>
    <SENTENCE>
      <WORD>This</WORD>
      <WORD>paragraph</WORD>
      <WORD>is</WORD>
      <WORD>separated</WORD>
      <WORD>from</WORD>
      <WORD>the</WORD>
      <WORD>previous</WORD>
      <WORD>paragraph</WORD>
      <WORD>by</WORD>
      <WORD>an</WORD>
      <WORD>ASCII</WORD>
      <WORD>carriage</WORD>
      <WORD>return/line</WORD>
      <WORD>feed</WORD>
      <WORD>byte</WORD>
      <WORD>sequence</WORD>.
    </SENTENCE>
  </PAPAGRAPH>
  </PAGE>
</DOCUMENT>
```

In one implementation, the sentences are parsed into parts of speech which marks each linguistic element such as Nouns, Verbs, Adjectives, and Adverbs with tags indicating the part of speech instead of the <WORD> tag. Linguistic tagging provides more information for the rule processing described below. This information makes it possible for relationships to be more specifically defined and searched. For example, with the linguistic parsing implementation, it is possible to distinguish between documents that mention the PRESIDENT as a noun as opposed to those that mention it as a direct object. Without the linguistic parsing (parsing into undifferentiated WORDS instead, the rule processing engine will tend to return documents that use the PRESIDENT tag contents in both forms.

Headings and titles can be recognized and tagged separately. This recognition process occurs during paragraph recognition. If a paragraph has the following criteria, it is tagged as a document heading. The <HEADING> tag occurs as a child of the <PARAGRAPH> tag. Headings are generally paragraphs which also have the following criteria:
The text is bolded
The paragraph is a single line in length

These elements are marked as headings inside the paragraph tags. An example of this is shown below:

```
<DOCUMENT>
  <PAGE>
  <PARAGRAPH>
    <HEADING>
      The heading of the first paragraph.
    </HEADING>
    <SENTENCE>
      The text of the first paragraph under the above
      heading follows in its own paragraph tag.
    </SENTENCE>
  </PARAGRAPH>
  <PARAGRAPH>
    <HEADING>
      The heading of the second paragraph.
    </HEADING>
    <SENTENCE>
      This paragraph is the paragraph under the second
      heading and is separated from the previous paragraph
      by an ASCII carriage return/line feed byte sequence.
    </SENTENCE>
  </PARAGRAPH>
  </PAGE>
</DOCUMENT>
```

<HEADING> tags are siblings of <SENTENCE> tags and are stored at the same level in the document hierarchy. This means that subsequent to SENTENCE parsing, the contents of HEADING tags are also surrounded by <WORD> tags.

```
<DOCUMENT>
  </PAGE>
  <PARAGRAPH>
    <HEADING>
      <WORD>The</WORD>
      <WORD>text</WORD>
      <WORD>of</WORD>
      <WORD>the</WORD><WORD>first</WORD>
      <WORD>paragraph</WORD>.
    </HEADING>
    <SENTENCE>
      <WORD>The</WORD>
      <WORD>text</WORD>
      <WORD>of</WORD>
      <WORD>the</WORD>
      <WORD>second</WORD>
      <WORD>paragraph</WORD>
      <WORD>follows</WORD>
      <WORD>in</WORD>
      <WORD>its</WORD>
      <WORD>own</WORD>
      <WORD>paragraph</WORD>
      <WORD>tag</WORD>.
    </SENTENCE>
  </PARAGRAPH>
  <PARAGRAPH>
    <HEADING>
      <WORD>The</WORD>
      <WORD>text</WORD>
      <WORD>of</WORD>
      <WORD>the</WORD>
      <WORD>second</WORD>
      <WORD>paragraph</WORD>.
    </HEADING>
    <SENTENCE>
      <WORD>This</WORD>
      <WORD>paragraph</WORD>
      <WORD>is</WORD>
      <WORD>separated</WORD>
      <WORD>from</WORD>
      <WORD>the</WORD>
      <WORD>previous</WORD>
      <WORD>paragraph</WORD>
      <WORD>by</WORD>
      <WORD>an</WORD>
      <WORD>ASCII</WORD>
      <WORD>carriage</WORD>
      <WORD>return/line</WORD>
      <WORD>feed</WORD>
      <WORD>byte</WORD>
      <WORD>sequence</WORD>.
    </SENTENCE>
  </PARAGRAPH>
  </PAGE>
</DOCUMENT>
```

A TITLE is recognized as the first heading in a document that is within a specified distance of the top of the first page. The calling program specifies the depth of the page in inches, millimeters or pixels in which a title will be recognized. TITLE tags are wrapped around these headings in the following manner:

```
<DOCUMENT>
  <PAGE>
  <PARAGRAPH>
    <TITLE>
      <HEADING>
        The heading of the first paragraph.
      </HEADING>
    </TITLE>
    <SENTENCE>
      The text of the first paragraph under the above
      heading follows in its own paragraph tag.
    </SENTENCE>
  </PARAGRAPH>
  <PARAGRAPH>
    <HEADING>
      The heading of the second paragraph.
    </HEADING>
    <SENTENCE>
      This paragraph is the paragraph under the second
      heading and is separated from the previous paragraph
      by an ASCII carriage return/line feed byte sequence.
    </SENTENCE>
  </PARAGRAPH>
  </PAGE>
</DOCUMENT>
```

Tags are hierarchical. That is, the <HEADING> tags and <SENTENCE> tags are children of <PARAGRAPH> tags which are children of <PAGE> tags which are children of <DOCUMENT> tags. <WORD> tags are the lowest level children of all of the above tags. <HEADING> and <SENTENCE> tags are the only sibling tags in the tag set.

### Contextual—Analysis Module

Contextual analysis (also called “query processing”) is the process of launching a project that has been previously defined with a relevance filter, which are collections of pre-defined and pre-stored rules. Projects and their rules are processed by the contextual-analysis module 130. This component can be manually started through a graphical user interface or can be automatically started using a project scheduler. Projects may be scheduled for immediate execution or for deferred or repeated execution.

When a project is executed, the contextual-analysis module 130 opens each rule (stored in the domain-knowledge system 105) in the relevance filters corresponding to the project. The contextual-analysis module 130, in one implementation, performs the following operations repeatedly until all the rules within a project have been processed:
1. Extract a rule from the relevance filter. (Block 200)
2. Extract the XSLT scripts from the relationships in the rule. (Block 205)
3. Extract an element from a knowledge set. (Block 210)
4. Package the Element in XML. (Block 215)
5. Apply the XSLT from the rule to the XML tag containing the element. (Block 220)
   This has the effect of creating an XSLT fragment with the value of the element replaced in the Rule's generic XSLT.
6. Apply the resulting XSLT script to the XML-encoded document. (Block 225)
   The result will be either the string ‘True’ or the string ‘False’
   If the result is ‘False’ the process is terminated and the document is discarded from the candidate list.
   If the result is ‘True’ the document is left on the candidate list and will be processed against the next rule in the filter. Any document that passes all the rules in a given filter with ‘True’ results is considered to be relevant to the query. Any document which has a value of ‘False’ returned by any rule in a given filter is considered irrelevant to the query posed by that filter.
   However, if a project contains more than one filter, a candidate document will be considered relevant to the entire query posed by the project if it passes through any of the filters as ‘True’. Therefore the above process is repeated from the beginning for each candidate Document and it is only at the end of this process that a candidate document is fully discarded.
7. Store references to documents that have passed the project's filters in memory for display when the project is complete or for building a package when the project is run in a batch mode. (Blocks 230 and 235)

Running these types of projects on structured data such as database tables is often problematic because the linguistic relationships between elements do not always exist in structured data. The data elements occur in records which can be said to contain information fields that are in some way related, but there is no relationship implied between two consecutive records retrieved by a query other than that the search criteria defined was satisfied by both records. For example, two customer invoice records might be retrieved by a query requesting invoice records with amounts greater than $10,000, but there is no reason to think that the two invoice records have any other relationship to each other without constructing yet another query or making the original query more complex. But by treating the returned record set as a complete document, the relevance rules or filter can be applied to determine if more significant relationships exist, without the burden of creating lengthy database queries.

Assuming that candidate documents (consisting of database records or other structured records) have been previously identified, the appropriate relevance filter can be applied. To return to the invoices example above, if all invoices with values greater than $10,000 are selected from the primary relational database, the contextual-analysis module 130 is used to determine the validity of the statement that “Tom's invoices were always issued 72 hours before Mary's”. This is accomplished by using a filter that contains the relationship “issued before.” The entire record set can be returned if the result of the relevance filters were true. If not, the record set is discarded as an inappropriate candidate.

### Document—Packgaging Module

Once a project has identified relevant documents, the packaging module 135 can package and store those documents. This type of packaging is important for compliance with statutes and internal procedures. Often, the document sets that satisfy a particular project are in different formats. For example, documents encoded in any electronic data stream format such as, but not limited to, American Standard Code for Information Interchange (ASCII) line data, Adobe Portable Document Format (PDF), IBM Advanced Function Printing (AFP), Hypertext Markup Language (HTML), extensible markup language (XML), or others, may need to be collected together and associated with one another.

The creation of such collections or objects, a process referred to as packaging, provides the end user with the ability to perform several consolidated operations on a collection of documents encoded in a heterogeneous mix of data stream formats and following a wide variety of standards. A package may be treated by application programs as, among other things: a single document, a document repository, a database of document-related information, a list of related documents, a list of random, unrelated documents, and a structured data stream describing documents.

In the context of this description, a package generally consists of an XML-encoded data stream which in turn contains or wraps other document data streams, while also providing metadata that is also encoded in XML. The package retains the original format of each data stream it contains and identifies them as separate documents.

An example Package structure would be:

```
Begin Package
    Begin Document
        Document is PDF
        PDF document
    End Document
    Begin Document
        Document is AFP
        AFP document
    End Document
    Begin Document
        Document is PDF
        PDF document
End Document
```

The basic structure of a package is that there is a root node tag, a document delimiting tag, tags containing meta data and a either a tag containing a document data stream or a tag containing a universal resource identifier (URI) that identifies the location of a document not included in the Package, but referenced by it. The data stream encapsulation or URI encapsulation tags and the metadata tags are siblings. That is they all occur as children of the document delimiting tag.

Packages come in two varieties. These are known as portable and non-portable. The difference is only in whether the package contains the actual data stream of all of its documents or only references to some of its documents. A package that contains any reference to an external document data stream is said to be a non-portable package. A package that contains only the entire contents of the document data streams packaged within it, with no external references, is said to be a portable package.

Portable packages fully contain the entire data stream (in any data stream format) of all the documents present in the package. Consequently, a portable package may be moved to portable media such as DVD or transmitted across networks from one computer to another as a single unit. Packages transferred to any computing device in any manner do not need the device to be connected to a network to use the package once it has been delivered to the receiving device.

Portable packages are fully contained and self sufficient in the sense that they do not need to include any other data for a consuming program to operate on them or to determine and manipulate all the documents they contain. Non-portable packages contain references to some or all of the documents present in the package. These references, in the form of XML uniform resource identifiers (URIs), point to locations locally or remotely across a network, where the actual data stream composing a particular document can be found. Consequently, non-portable packages cannot be safely moved from the system on which they reside. While the URIs used as references to actual documents may be fully qualified and allow for the location and transmission of the referenced document from any networked computer, this is not guaranteed. Specifically, non-portable packages, if moved to a portable media such as CD-Rom or DVD, are not self sufficient in the sense that they do need to include other data for a consuming program to operate on them.

The XML wrapper of a package is an arbitrary XML language. The package does not define the XML language to be used and an XML data stream qualifies as a package as long as it contains self describing data elements that encapsulate document data streams or URI's. These references can be in the form of a URI and may reference local documents as long as they are resolvable by the computer creating the package. Document reference URI's are omitted from portable packages. The presence of any document reference invalidates the portability of a package.

Packages are created by a program known generically as a packaging module. Typically, a packaging module is an internal object with no user interface. Rather, it is invoked multiple times to add individual documents to a growing package.

First, the packaging module is called with an initialization parameter to create a new package template in memory. This initialization phase also instantiates a handle to the XML document that represents the package. A packaging module may choose any tag set for the package it chooses or it may be written such that another program chooses the tag names for the package. The initial package instantiation contains only a root node tag. In the example below, the root node tag is a <PACKAGE> tag, but the root node may have any arbitrary tag name in a package.

Responsive to subsequent calls to the packaging module, either an entire document currently held in memory is handed to it on each call or a Universal Resource Identifier (URI) is passed as a document URI on each call. If a document is passed to the packaging module, it is added to the package that is growing in memory. Each document that is added is surrounded by document delimiting tags. In the example below, the document delimiting tag is <DOCUMENT> but that is not necessary. Any tag name may be used for a package's document delimiting tag.

Document delimiting tags have several children as described above. A document type tag (<DOCTYPE> is arbitrarily used in the example below) is created when a document is added. If the document itself is passed in, a document data tag is created (<DOCDATA> in the example). This tag encapsulates the document data stream. If, instead, a document URI (107) for a document is passed to the packaging module, it is encapsulated in a document location tag (<DOCURI> in the example).

The packaging module may add other metadata tags to a package. For example, it may add a document-creation data tag, a document-date tag, a last-used tag, a document-access-parameter tag, or any other tags containing metadata about the document inside each document delimiting tag.

The last invocation of the packaging module is an invocation where a termination parameter is passed to the packaging module. This parameter causes the packaging module to perform finalization processing by adding the closing tag for the root node tag (</PACKAGE> in the example below), then setting a return code to tell the higher level program that termination has been performed.

This is an example of a non-portable package because it contains a document reference in the form of a URI. Note that a <CREATEDATE> tag specifying the creation date is in this particular package, but that is both an optional and arbitrarily named tag. Its presence or absence does not change the fact that this XML stream is a package in the sense of this document.

```
<PACKAGE>
  <DOCUMENT>
    <DOCTYPE>PDF</DOCUMENT>
    <CREATEDATE>2004/04/22</CREATEDATE>
    <DOCDATA>
      a stream of data representing a PDF document
    </DOCDATA>
  </DOCUMENT>
  <DOCUMENT>
    <DOCTYPE>AFP</DOCTYPE>
    <CREATEDATE>2004/03/17</CREATEDATE>
    <DOCURI>
      http://www.myserver.com/afp/document1.afp
    </DOCURI>
  </DOCUMENT>
</PACKAGE>
```

This is an example of a portable package.

```
<PACKAGE>
  <DOCUMENT>
    <DOCTYPE>PDF</DOCUMENT>
    <CREATEDATE>2004/04/22</CREATEDATE>
    <DOCDATA>
      a stream of data representing a PDF document
    </DOCDATA>
  </DOCUMENT>
  <DOCUMENT>
    <DOCTYPE>AFP</DOCTYPE>
    <CREATEDATE>2004/03/17</CREATEDATE>
    <DOCDATA>
      a stream of data representing an AFP document
    </DOCDATA>
  </DOCUMENT>
</PACKAGE>
```

To save space while packaging documents, data compression and/or optimization can be used. Data compression is the process of reducing the amount of data in a file by finding patterns in the data and representing those patterns in fewer bytes than they originally occupied. This process is context-free. That is, the algorithm knows nothing about the meaning of the data, only the patterns it finds as it reads the data. Many compression algorithms exist, such as Run Length Encoding, FLATE®, or LZW®^{.}

Optimization is another form of data size reduction but it is not context-free. Optimization is the process of reducing the data size by transcoding elements in the known data stream into smaller representative units. For example, an 8-byte field that can contain only one of three different values can be reduced to a pair of bits if each bit pattern is assigned one of the words in a known fashion. Typically the knowledge of how to assign such enumerated values to each bit pattern is encoded in the optimizing program. Thus each optimization program is typically a custom program specialized for only one task and file format.

The current invention is a method of externalizing optimization by allowing a user to define an XML file 240 that specifies the transcoding of field values into bit fields. The transcoding definition 245 is created by an interactive program with a graphical interface. This definition is saved as an XML file. The definition is then applied to a file by a program object which interprets the XML file and reads a matching input file, then returns a new file with the transcoded fields. The process of defining and using a transcoding definition has several phases. The first phase is definition, the second is actual transcoding, the final phase is reverse transcoding.

The definition phase of the process begins with a graphical user interface 250 that presents a hierarchical display of data 255 that allows the user to load a data file 260 and see a hierarchical display 255 of data representing structure of the data file.

The user can create the view manually, if necessary, using drag and drop features of the interface 250 that presents the hierarchical display of data 255. The hierarchical view can be created if no existing structure definition is available by entering field names and dragging them to specific locations in the hierarchical display of data representation of the data file. This step can be skipped, however, if a matching data definition in the form of a Cobol Copy Book, C Data Structure, or XML Schema is available that represents the structure of the Data File.

If data definitions 260 in the form of a Cobol Copy Book, C Data Structure, or XML Schema already exist, the program can load such definitions into the hierarchical display of data. These definitions 260 will define the view in the hierarchical display of data that the user sees of the data file to be optimized.

Once a hierarchical view of the data file is available in the hierarchical display of data 255, the user can move on to the transcoding definition. The transcoding definition is where rules are defined that specify how the transcoding of fields in the data file are to occur. This involves the user using the point-and-click selection of data fields from the hierarchy operation which causes them to appear in the transcoding definition interface. The user selects fields for transcoding, then specifies the possible values for those fields and the type of transcoding to be performed. Transcodings can be string-to-byte representation where strings are encoded as specific bytes; string-to-bit representations where strings are encoded as bit fields; number-to-bit fields where numerical values are represented as bit fields; or string-to-string translations that simply replace one string with another.

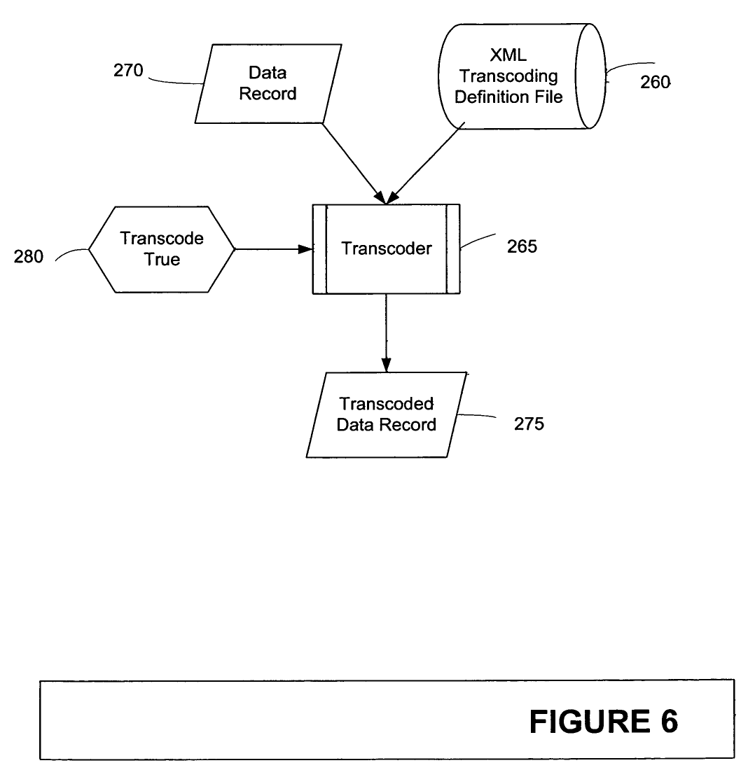

Referring now to FIG. 6, it illustrates another embodiment for transcoding. Transcodings can only be performed on fields with a limited and precise set of possible values. A set of string values, a range of numeric values, or any other well definable set of values can be transcoded. The number of bits needed to encode a specific set of values will be determined by the program as the user enters value specifics.

Once the transcoding definition is complete, the user can save the definition as an XML format file called the XML transcoding definition file 260. It can be recalled and edited if necessary. The final form of the definition file, in this implementation, is used by the transcoder 270, which is handed a data record 265 to be transcoded. This record will typically come from the data file. The record 265 is processed against an XML-based transcoding definition which is used to create a new version of the record 275 that requires fewer bytes because many of its fields have been transcoded. The transcoding definition will be one that was defined in the transcoding definition and stored by that process as an XML transcoding definition file.

The transcoder is also handed a Transcode=“True” parameter 280 which instructs it to perform the transcoding of data fields in the data record 270. The resulting new record 275 is created as a transcoded data record. Individual transcoded fields in the transcoded data record may take up less than a single byte. Because of this the transcoded fields are collected together into the last few bytes of the new transcoded data record. Fields that are not transcoded when they are placed in the transcoded data record will occur in the new reduced record in the same order as they occur in the original data record.

Reverse Transcoding is the process of recovering a valid copy of the original data record from a transcoded data record. The same transcoder program object that performs transcoding can also perform the reverse process, decoding the transcoded fields of a transcoded data record using the map of transcoded fields present in the XML transcoding definition to place the expanded fields in new output records that look exactly the same as the originals. To do this, the object must be handed both a transcoded data record and the XML transcoding definition. A Transcode=“False” parameter is handed to the transcoder to instruct it to perform the action of decoding a transcoded data record instead of transcoding it. Reverse transcodings can be byte to string representation where strings have been encoded as specific bytes; bit to string representations where strings have been encoded as bit fields; bit fields to numbers where numerical values have been represented as bit fields; or string to string translations that simply replace one string with another.

Decoding the data is performed by reading the XML transcoding definition, then deriving where the transcoded data will start. Each record is then examined and the transcoded bits are reversed into the appropriate original data in a context sensitive manner. The knowledge of what enumerated values are available for the reverse transcription process is stored in the XML transcoding definition file.

Data fields from the transcoded data record are reconstructed and restored to a new record in memory called the original data record with original fields in the transcoded data record specifically, placed in the proper hierarchical context as defined by the XML transcoding definition file. Therefore, the reconstructed original data record is the same as the input record. All evidence of transcoding is removed.

There is one exception to this process. If a transcoding operation for a specific field is defined in the XML transcoding definition file such that a non-reversible substitution is to be made, the permanent transcoding handler detects this and the transcoded field is replaced in the proper location in the original data hierarchy, but the original data is not restored. This provides the ability to perform translations as well as transcodings. For example, the letter “I” in the original data can be substituted with a “K” in the final original data record.

In conclusion, the present invention provides, among other things, a system and method for managing data repositories and locating information in those data repositories. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for managing a data repository, the method comprising:
receiving an index corresponding to a document;
receiving metadata corresponding to the document;
using the received metadata, identifying a rule that corresponds to the index, the rule comprising a plurality of knowledge sets and definitions that define relationships between the plurality of knowledge sets;
determining whether the document is a candidate document by comparing at least one of the plurality of knowledge set against the received index;
responsive to determining that the document is a candidate document, generating a tagged document; and
determining whether the document satisfies the rule by comparing the tagged document against the definition that define the relationships between the plurality of knowledge sets.

2. The method of claim 1, further comprising:
responsive to the document satisfying the rule, packaging the document in a portable package.

3. The method of claim 1, further comprising:
responsive to the document satisfying the rule, packaging the document in a non-portable package.

4. The method of claim 1, wherein receiving metadata corresponding to the document comprises:
receiving metadata indicating the location where the document is stored.

5. The method of claim 1, wherein receiving metadata corresponding to the document comprises:
receiving metadata indicating the author or recipient of the document.

6. The method of claim 1, wherein the knowledge set comprises a plurality of elements and wherein determining whether the document is a candidate document comprises:
searching the index for the plurality of elements.

7. The method of claim 1, wherein generating a tagged document comprises:
applying XML tags to the document.

8. A method for monitoring data, the method comprising:
defining a project for monitoring data included in documents;
associating a plurality of knowledge sets with the defined project;
defining relationships among the knowledge sets;
associating the defined relationships with a rule;
associating the rule with the project; and
applying the project to a document to determine if the document satisfies the rule.

9. A system comprising:
a domain-knowledge system;
a candidate-document-identification module in communication with the domain-knowledge system;
a tagging module in communication with the candidate-document-identification module; and
a contextual-analysis module in communication with the tagging module and the domain-knowledge system.

10. The system of claim 9, further comprising:
a packaging module in communication with the contextual-analysis module.

11. The system of claim 9, further comprising:
an index-building module in communication with the candidate-document identification module;

12. A system for managing a data repository, the method comprising:
means for generating an index corresponding to a document;
means for identifying metadata corresponding to the document;
means for identifying a rule that corresponds to the index, the rule comprising a plurality of knowledge sets and definitions that define relationships between the plurality of knowledge sets;
means for determining whether the document is a candidate document by comparing at least one of the plurality of knowledge set against the received index;
means for tagging the document; and
means for determining whether the document satisfies the rule

13. A method for managing a data repository, the method comprising:
receiving metadata corresponding to the document;
using the received metadata, identifying a rule that corresponds to the document, the rule comprising a plurality of knowledge sets and definitions that define relationships between the plurality of knowledge sets;
determining whether the document is a candidate document by comparing at least one of the plurality of knowledge set against the received index; and
determining whether the document satisfies the rule by comparing the document against the definition that define the relationships between the plurality of knowledge sets.
